(19) United States
(12) Patent Application Publication
(10) Pub. No.: US 2006/0057458 A1
(43) Pub. Date: Mar. 16, 2006

(54) Battery with integrated protection circuit

(76) Inventors: Michael J. O'Dea, Donabate (IE); Neill B. Boyle, Dublin 5 (IE); David A. Long, Dublin (IE)

Correspondence Address: MOTOROLA INC, 600 NORTH US HIGHWAY 45, ROOM AS437, LIBERTYVILLE, IL, 60048-5343, US

(21) Appl. No.: 10/941,327

(22) Filed: Sep. 15, 2004

(51) Int. Cl. H01M 2/02; H01M 2/04

(52) U.S. Cl. 429/164; 429/7; 429/175

(57) ABSTRACT

A battery pack is provided where the cell can becomes the battery enclosure. An electrode assembly is deposited within a can. A recess area is created above the electrode assembly by either extending the sides of the can beyond the electrode assembly or by attaching a tubular header to the can. An optional, insulating, plastic cup is then placed within the recess area. A printed circuit board that includes battery safety circuitry is then placed within the recess area and coupled to positive and negative electrical terminals on the end of the can. A sealing cap is then placed atop the cup to seal the printed circuit board within the overall package. The sealing cap includes electrical connections for coupling to the printed circuit board. The resulting sealed package offers a compact and robust, yet safe, energy storage and delivery system.

### BACKGROUND

1. Technical Field

This invention relates generally rechargeable battery packs, and more particularly to compact, robust battery packs for small electronic devices.

2. Background Art

Toray's electronic devices are becoming smaller and smaller. For example, a cellular telephone, which used to be the size of a man's shoe, now fits easily within a shirt pocket. Similarly, personal computing devices, which used to be as big as a metropolitan telephone book, now fit easily within the palm of the hand.

As the size of these portable devices gets smaller, so too must their energy sources become smaller. Nearly all portable electronic devices rely upon rechargeable batteries for their portability. While some may think that a rechargeable battery pack is simply an electrochemical cell in a box, nothing could be farther from the truth. Rechargeable battery packs are complex devices that include mechanical interconnects, safety, charging and fuel gauging circuits, and electromechanical devices as well. Many times, battery pack size becomes the limiting factor in the amount of size reduction of the overall electronic device.

Battery pack designers have attempted various size reduction techniques in the past. One popular way to reduce the overall battery pack size is by embedding the battery in the electronic device and removing the exterior housing. For example, in some handheld computers, the battery is sealed within the device and is not replaceable by the user. In these designs, engineers often opt not to include a plastic housing about the cell. They simply wrap a label about the battery. This solution, however, fails to address what happens to the mechanical, electromechanical and circuitry components, some of which are left flopping about the battery. Further, many electronic device manufacturers want users to be able to replace batteries. Label wrapped batteries may not facilitate this replacement capability.

There is thus a need for an improved, compact, self-contained, rechargeable battery pack.

### BRIEF DESCRIPTION OF THE DRAWINGS

FIG. 1 illustrates a battery pack assembly in accordance with the invention.

FIG. 2 illustrates an alternate embodiment of a battery pack assembly in accordance with the invention.

FIG. 3 illustrates a sectional view of one embodiment of a sealing cup in accordance with the invention.

FIG. 4 illustrates a sectional view of one embodiment of a battery pack in accordance with the invention.

FIG. 5 illustrates a completed battery pack in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention provides a self-contained, reliable energy storage device that includes an internal battery safety circuit. An electrode assembly, which includes an anode, cathode and electrolyte, and forms a rechargeable cell, is sealed in a can. A positive and negative electrical terminal, coupled to the cathode and anode, respectively, are located at one end of the can.

A recess area, which may be created in a variety of ways, exists about the positive and negative electrical terminals and extends distally from the end of the can. A printed circuit board assembly, which may include battery safety circuitry, charging circuitry, identification circuitry and/or fuel gauging circuitry is positioned within the recess area. The printed circuit board assembly is electrically coupled to the positive and negative electrical terminals.

A cap is then positioned over the recess area, thereby sealing the printed circuit board assembly within the recess area. The cap includes at least two electrical terminals, which are in turn coupled to the printed circuit board. The result is a self contained, reliable and easy to manufacture rechargeable battery pack.

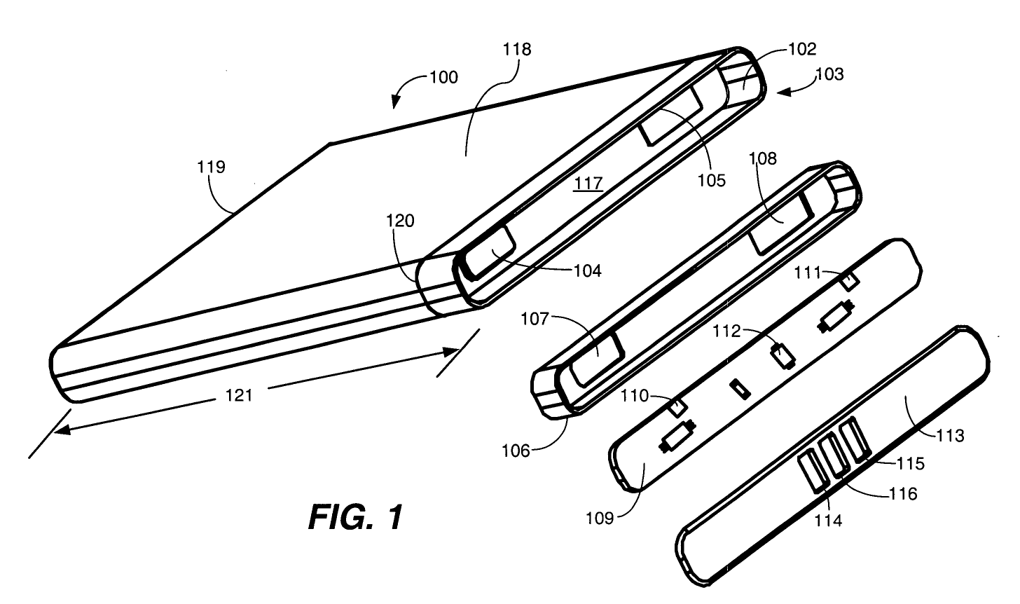

Turning now to FIG. 1, illustrated therein is one preferred embodiment of a battery pack in accordance with the invention. The components of the battery assembly are shown in an exploded, perspective view.

A rechargeable cell is disposed within a sealed can 100. The rechargeable cell comprises a cathode and an anode, with an electrolyte disposed about the anode and cathode. The anode and cathode may be layered together and wrapped about each other to form a “jelly roll” structure as is known in the art. Such an anode and cathode structure is taught in commonly assigned U.S. Pat. No. 6,574,111, entitled “Impact resistant rechargeable battery cell with crumple zone”, which is incorporated herein by reference for all purposes. Alternately, the anode and cathode may be constructed in a solid, prismatic structure with a polymer gel electrolyte as is taught in U.S. Pat. No. 5,837,015, entitled “Method of making a multilayered gel electrolyte bonded rechargeable electrochemical cell”, which is incorporated herein by reference for all purposes.

The sealed package or can 100 is preferably metal or alloys, although it will be clear to those of ordinary skill in the art having the benefit of this disclosure that other materials, including plastic, may equally be used. Metal is one preferred material due to its rugged durability. Additionally, the can 100 for polymer cells may be constructed by wrapping metallic materials like foils about the polymer cell. The can 100 is sealed by a first end piece 117 so that the electrodes and electrolyte are completely contained within the can.

The can 100 generally has a second end 119 and sides 118 that extend from the second end 119. Such a can 100 is typically manufactured by an extrusion process, although some manufacturers may choose to weld or otherwise attach the second end 119, or “bottom”, to the sides 118 of the can 100. The can is then sealed with the first end 117, generally with a crimp seal or weld.

The first end 117 of the can has a positive, or “cathode”, electrical terminal 104 and a negative, or “anode”, electrical terminal 105 attached thereto. The positive terminal 104 and negative terminal 105 are coupled to the cathode and anode of the electrode assembly, respectively. While two terminals 104,105 are shown in this illustrative embodiment, some cell manufacturers will include only one terminal (affectionately known as the “button”) and will allow a portion of the can 100, like the first end 117, to serve as the second terminal. For example, the “button” may be the positive terminal 104, and the first end 117 will serve as the negative terminal (or vice versa). Additionally, in other embodiments, either the positive or negative terminals 104,105 may be at alternate locations on the can 100. For example, one or both of the terminals may not be disposed on the first end 117 of the can 100, but rather on one of the side 118 of the can 100. In such an embodiment, insulated tabs may be employed to couple the terminals 104,105 with the tubular header 102.

A tubular header 102 extends distally from the first end 117 so as to form a recess area 103. The tubular header 102 may simply be an extension of the sides beyond the first end 117, or it may be an open ended tube having a cross section roughly equivalent to that of the can 100 that is attached after the cell assembly is completed. The tubular header 102 may be of a like material with that of the can 100, or it may be of a different material.

For example, in one embodiment, the can 100 has a can length 121 that is greater than the length of the electrode assembly disposed within the can, i.e. the “electrode length”. Once the electrode assembly is seated within the can 100, the sides 118 extend beyond the electrode assembly due to their extended length. The first end 117 may then be coupled to and positioned atop the electrode assembly, within the sides 118, and affixed with either a crimp connection or weld along line 120. In so doing, the recess cavity 103 is created with a tubular header 102 that is essentially the sides 118 of the can 100 extending beyond the first end 117.

In another embodiment, the tubular header 102 may actually be a separate piece of open-ended can material that is attached after the rechargeable cell is assembled. In this embodiment, the rechargeable cell would consist of the sides 118, which are closed by the first end 117 and the second end 119. A separate tubular header 102 is then attached to the end 117 of the can 100 that includes the positive and negative electrodes 104,105. The tubular header 102 is preferably coupled to the can by welding along line 120, although other connection mechanisms, including glue, snaps or friction connection may also be employed.

An optional cup 106 is then inserted into the recess area 103 within the tubular header 102. The cup 106 is preferably manufactured from plastic due to its electrically insulating properties, although other materials may also be used. The cup 106 has apertures 107,108 that provide access to the positive and negative electrical terminals 104,105. The cup 106 may be permanently affixed to the within the tubular header 102 by a mechanism selected from the group consisting of press fit connections, snap fit connections, glued connections, and welded connections.

A printed circuit board 109 is then placed within the plastic cup 106. The printed circuit board 109 includes battery safety circuitry 112, but may include charging circuitry, identification and recognition circuitry, anti-counterfeiting or authentication circuitry, and/or fuel gauging circuitry as well. One example of a suitable battery safety circuit 112 is taught in commonly assigned U.S. Pat. No. 5,569,550, entitled “Battery Pack having Over Voltage and Under Voltage Protection”, which is incorporated herein by reference for all purposes.

The printed circuit board 109 also includes electrically conductive pads 110,111 and traces for interconnecting the various circuit components. Alternatively, contact blocks may be substituted for the conductive pads 110,111. The positive and negative electrical terminals 104,105 are coupled to pads 110,111 of the of the printed circuit board 109. This coupling may be done by flexible metal tabs that are welded to the terminals 104,105 and soldered or welded to the pads 110,111. It will be clear to one of ordinary skill in the art having the benefit of this disclosure that other conductors, in addition to flexible metal tabs, may be used to couple the terminals 104,105 to the pads 110,111. For example, wires, flexible circuit substrates or conductive adhesives may equally be used.

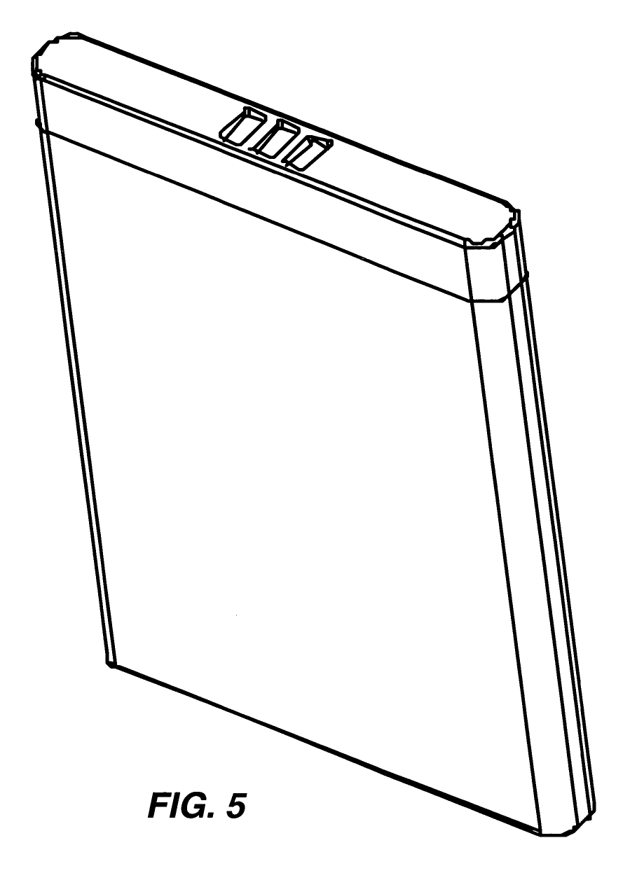

A cover 113, or “sealing cap” or “can cap”, is then placed atop the cup 106 and tubular header 102 so as to seal the printed circuit board within the overall package. The sealing cap 113 may be metal, which may be welded to the tubular header 102. Alternatively, the sealing cap 113 may be plastic and may be affixed to the cup 106 by a mechanism selected from the group consisting of press fit connections, snap fit connections, crimped connections, screwed or riveted connections, glue connections, adhesive connections (including tapes, epoxies, etc.), heat staked connections, sonically staked connections and ultrasonically welded connections. In one embodiment, when the sealing cap is affixed to the plastic cup, the printed circuit board is encapsulated so as to prevent liquid intrusion into the battery. The completed battery assembly is shown in FIG. 5.

The cover 113 includes a positive, or cathode, terminal 114 and a negative, or anode, terminal 115. These terminals 114,115 may be insert molded into the, cover 113. The positive terminal 114 and negative terminal 115 may be coupled to the printed circuit board, the positive and negative can terminals 104,105 or a combination of both. A combination may occur where the printed circuit board 109 is coupled serially between the positive cell terminal 104 and the positive cover terminal 114 for instance, while the negative connections from printed circuit board 109 to negative cell terminal 105 and negative cover terminal 115 to negative cell terminal 105 are in parallel to a single node. Additional terminals 116 may be provided to couple to components like thermistors and memory or identification devices that may be included with the safety circuit 112.

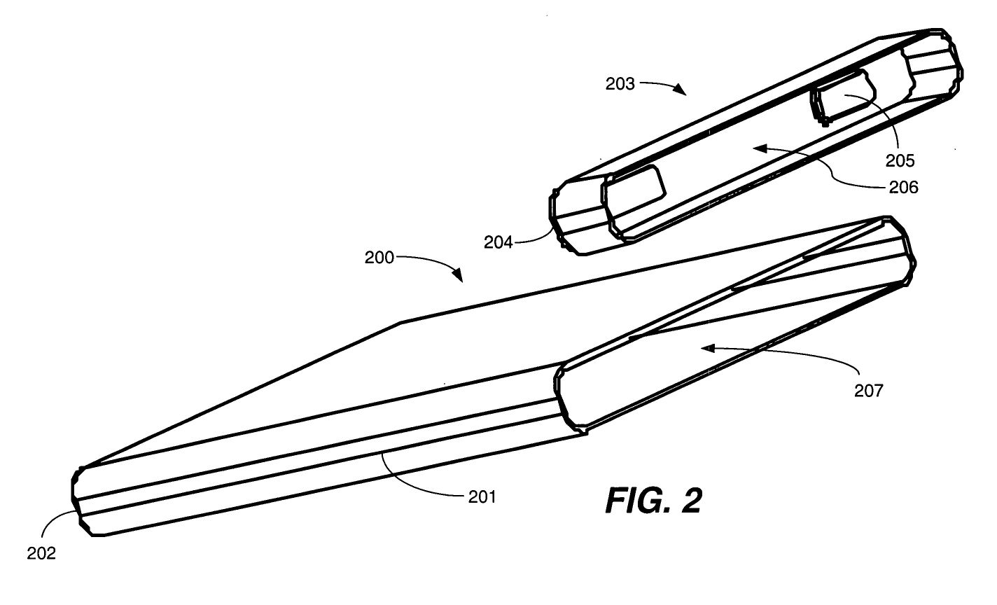

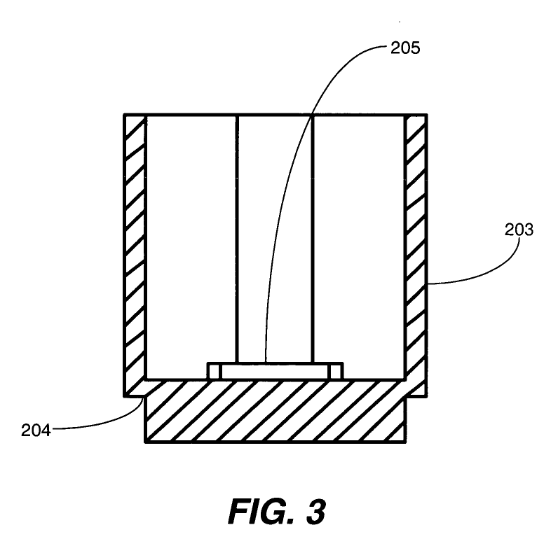

Turning now to FIG. 2, illustrated therein is an alternate embodiment of the invention. In this embodiment, the can 200 having sides 201, at least one opening 207 and an end 202 is constructed as described above. The electrode assembly and electrolyte (not shown) are then inserted into the can 200. A cup 203 having an opening 206 a mating connection 204 for coupling to the sides 201 of the can 200 is then positioned atop the electrode assembly within the can, so as to form a sealing member atop the electrode assembly. A cross section of the cup 203 is shown in FIG. 3. The cup 203 may be constructed such that the electrical connections 205 are integral with the cup 203. These electrical connections 205 are then coupled to the electrode assembly prior to coupling the cup 203 to the can 200.

A battery safety circuit, as described with respect to FIG. 1, may then be placed within the cup 203 and coupled to the electrical terminals 205, and thus to the electrode assembly within the can 200. A can cap, as described with respect to FIG. 1, is then positioned atop the cup 203, the can cap including at least one electrical contact. The electrical contact on the can cap is electrically coupled to the at least one battery safety circuit. The can cap closes the opening 206 of the cup 203.

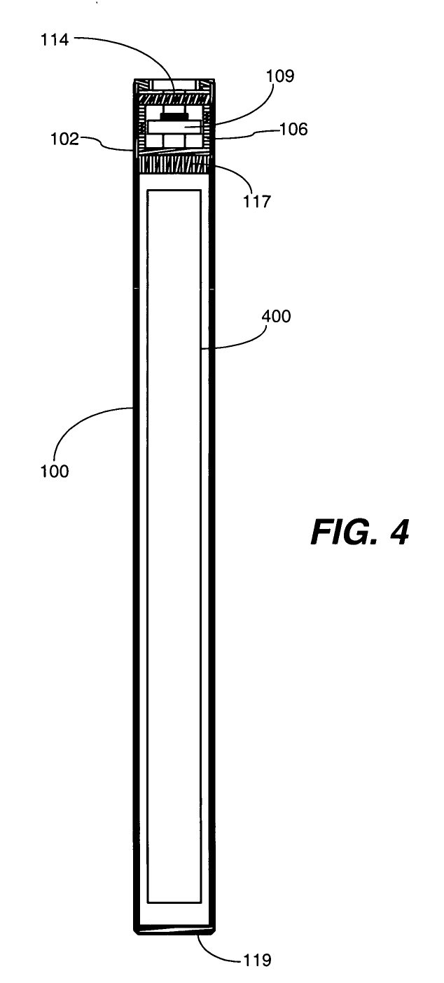

Turning now to FIG. 4, illustrated therein is a sectional view of the completed battery assembly. From this view, the electrode assembly 400, seated in the can 100, is visible. The first end 117, which seals in the electrolyte, is coupled to the can 100. The cup 106, with the printed circuit board and safety circuit 109 disposed therein, can be seen above the first end 117. The cap 117, which when coupled to the cup 106, seals the cup so as to prevent the electrolyte from contacting the battery safety circuit assembly, is also visible, as is the tubular header 102.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A battery pack, comprising:
a. a can having a can length, the can having at least one opening;
b. an electrode assembly having an electrode length, wherein the electrode length is less than the can length, the electrode assembly being positioned within the can;
c. an electrolyte disposed about the electrode assembly;
d. a cup positioned atop the electrode assembly within the can;
e. at least a battery safety circuit assembly disposed within the cup, the battery safety circuit assembly being electrically coupled to the electrode assembly; and
f. a can cap positioned atop the cup, the can cap comprising at least one electrical contact, wherein the at least one electrical contact is electrically coupled to the at least one battery safety circuit, further wherein the can cap closes the at least one opening.

2. The battery pack of claim 1, wherein the can cap, when placed atop the cup, seals the cup so as to prevent the electrolyte from contacting the battery safety circuit assembly.

3. The battery pack of claim 2, further comprising charging circuitry disposed within the cup and electrically connected to both the electrode assembly and the at least one electrical contact.

4. The battery pack of claim 2, further comprising identification circuitry disposed within the cup and electrically connected to both the electrode assembly and the at least one electrical contact.

5. The battery pack of claim 1, wherein the each of the can and cup is manufactured from a material selected from the group consisting of metal and plastic.

6. The battery pack of claim 5, wherein the can cap is coupled to the can by a mechanism selected from the group consisting of snaps, friction fits, glues, adhesives, heat stakes, sonic stakes and welds.

7. The battery pack of claim 1, wherein the cup is formed by coupling a sealing member to the walls of the can atop the electrode assembly.

8. A battery assembly, comprising:
a. a rechargeable cell disposed in a sealed can, wherein the sealed can comprises a first anode terminal and a first cathode terminal on a first end of the sealed can;
b. a tubular header extending distally from the first end of the can;
c. a printed circuit board electrically coupled to at least one of the first anode terminal and the first cathode terminal; and
d. a cover coupled to the tubular header, wherein the cover comprises a second anode terminal and a second cathode terminal, wherein at least one of the second anode terminal and second cathode terminal is electrically coupled to the printed circuit board.

9. The battery assembly of claim 8, further comprising a plastic cup disposed within the tubular header.

10. The battery assembly of claim 9, wherein the plastic cup is affixed within the tubular header by a mechanism selected from the group consisting of press fit connections, snap fit connections, crimped connections, screwed or riveted connections, glued connections, adhesive connections, heat staked connections, sonically staked connections and welded connections.

11. The battery assembly of claim 10, wherein the cover is affixed to the plastic cup by a mechanism selected from the group consisting of press fit connections, snap fit connections, glued connections, and welded connections.

12. The battery assembly of claim 8, wherein the tubular header is coupled to the sealed can by way of a method selected from the group consisting of welding and gluing.

13. An energy storage device, comprising:
a. at least one rechargeable cell, the at least one rechargeable cell comprising a cathode and an anode disposed in a sealed package, wherein the sealed package comprises a first end, a second end, and sides, wherein the sides extend distally beyond at least one of the first end and the second end;
b. at least a positive and a negative electrical terminal disposed on at least one of the first end and the second end;
c. a printed circuit board disposed within a portion of the sides extending distally beyond at least one of the first end and the second end; and
d. a sealing cap coupled to the portion of the sides extending distally beyond at least one of the first end and the second end so as to cover the printed circuit board.

14. The energy storage device of claim 13, further comprising a plastic cup disposed within the portion of the sides extending distally beyond at least one of the first end and the second end so as to cover the printed circuit board.

15. The energy storage device of claim 14, wherein the sealing cap is affixed to the plastic cup by a mechanism selected from the group consisting of press fit connections, snap fit connections, glued connections, and welded connections.

16. The energy storage device of claim 15, wherein the sealing cap comprises at least two electrical terminals coupled to the printed circuit board.

17. The energy storage device of claim 15, wherein when the sealing cap is affixed to the plastic cup, the printed circuit board is encapsulated so as to prevent liquid intrusion into the battery.

18. The energy storage device of claim 13, wherein the portion of the sides extending distally beyond at least one of the first end and the second end comprises a tubular header welded to the sealed package.

19. The energy storage device of claim 13, wherein the printed circuit board comprises a circuit selected from the group consisting of safety circuitry, charging circuitry, identification circuitry, recognition circuitry, anti-counterfeiting circuitry, authentication circuitry and fuel gauging circuitry
